(19) United States
(12) Patent Application Publication
(10) Pub. No.: US 2014/0156941 A1
(43) Pub. Date: Jun. 5, 2014

(54) Tracking Non-Native Content in Caches

(71) Applicant: ADVANCED MICRO DEVICES, INC., Sunnyvale, CA (US)

(72) Inventors: Gabriel H. Loh, Bellevue, WA (US); Mithuna S. Thottehodi, Bellevue, WA (US); Yasuko Eckert, Kirkland, WA (US); James M. O'Connor, Austin, TX (US); Mauricio Breternitz, Austin, TX (US); Bradford M. Beckmann, Redmond, WA (US); Nuwan Jayasena, Sunnyvale, CA (US)

(73) Assignee: Advanced Micro Devices, Inc., Sunnyvale, CA (US)

(21) Appl. No.: 13/691,375

(22) Filed: Nov. 30, 2012

(51) Int. Cl. G06F 12/08

(52) U.S. Cl. CPC G06F 12/0891
USPC 711/133; 711/118

(57) ABSTRACT

The described embodiments include a cache with a plurality of banks that includes a cache controller. In these embodiments, the cache controller determines a value representing non-native cache blocks stored in at least one bank in the cache, wherein a cache block is non-native to a bank when a home for the cache block is in a predetermined location relative to the bank. Then, based on the value representing non-native cache blocks stored in the at least one bank, the cache controller determines at least one bank in the cache to be transitioned from a first power mode to a second power mode. Next, the cache controller transitions the determined at least one bank in the cache from the first power mode to the second power mode.

### BACKGROUND

1. Field

The described embodiments relate to caches in electronic devices. More specifically, the described embodiments relate to a technique for tracking non-native content in caches.

2. Related Art

Many modern electronic devices include a processing subsystem with one or more caches. For example, laptop/desktop computers, smart phones, set-top boxes, appliances, and other electronic devices can include a processing subsystem with one or more caches. Caches are generally small, fast-access memory circuits located in or near the processing subsystem that can be used to store data that is retrieved from other, larger caches and/or memories in the electronic device to enable faster access to cached data.

Some of these electronic devices, particularly those operated on battery power, operate under tight electrical power consumption constraints. In such devices, portions of the processing subsystem and/or the cache can be placed in a reduced-power mode to enable conservation of electrical power (albeit at a cost in terms of the performance of the device). For example, in some electronic devices, the caches can include a set of banks, and individual banks can be powered down to help conserve power. However, in existing systems, when banks are powered down in a cache, the banks are powered down in a predetermined order, which can be inefficient.

### SUMMARY

The described embodiments include a cache with a plurality of banks that includes a cache controller. In these embodiments, the cache controller determines a value representing non-native cache blocks stored in at least one bank in the cache, wherein a cache block is non-native to a bank when a home for the cache block is in a predetermined location relative to the bank. Then, based on the value representing non-native cache blocks stored in the at least one bank, the cache controller determines at least one bank in the cache to be transitioned from a first power mode to a second power mode. Next, the cache controller transitions the determined at least one bank in the cache from the first power mode to the second power mode.

In some embodiments, each bank in the cache comprises a tracking mechanism for keeping track of non-native cache blocks stored in the bank. In these embodiments, when storing a non-native cache block in a bank in the cache, the cache controller is configured to update the tracking mechanism for the bank to indicate that the non-native cache block was stored in the bank. Additionally, when evicting a non-native cache block from a bank in the cache, the cache controller is configured to update the tracking mechanism for the bank to indicate that the non-native cache block was evicted from the bank. When determining the value representing non-native cache blocks stored in the at least one bank in the cache, the cache controller is configured to acquire the value from the tracking mechanism for the at least one bank.

In some embodiments, the tracking mechanism for each bank in the cache includes a counter. In these embodiments, the cache controller is configured to increment the counter for a bank as a non-native cache block is stored to the bank and decrement the counter for a bank as a non-native cache block is evicted from the bank. In these embodiments, the above-described value representing the non-native cache blocks stored in the bank is proportional to a value of the counter for the bank.

In some embodiments, the tracking mechanism for each bank in the cache includes an aggregate separation variable. In these embodiments, when storing a cache block to a bank in the cache or evicting a cache block from a bank in the cache, the cache controller is configured to determine a separation between a home for the cache block and the bank. The cache controller then computes an update value based on the separation. Next, the cache controller increases a value of the aggregate separation variable by the update value as a non-native cache block is stored to the bank and decreases the value of the aggregate separation variable by the update value as a non-native cache block is evicted from the bank. In these embodiments, the above-described value representing the non-native cache blocks stored in the bank is proportional to a value of the aggregate separation variable for the bank.

In some embodiments, when storing a non-native cache block in a bank in the cache, the cache controller is configured to update metadata for the cache block to indicate that the cache block is non-native. In some embodiments, when evicting a cache block from a bank in the cache, responsive to reading the metadata for the cache block and determining that the evicted cache block is non-native, the cache controller is configured to update the tracking mechanism for the bank to indicate that the non-native cache block was evicted from the bank.

In some embodiments, the cache controller is configured to compare at least one address for the cache block to at least one address that is predetermined to be non-native and, based on the comparison, determine that the cache block is non-native.

In some embodiments, the predetermined location relative to the bank comprises another bank in the cache, another cache, or a memory.

In some embodiments, the first power mode is a higher-power mode and the second power mode is a lower-power mode. In some embodiments, the first power mode is the lower-power mode and the second power mode is the higher-power mode.

In some embodiments, when determining at least one bank in the cache to be transitioned from a first power mode to a second power mode, the cache controller is configured to determine an order in which two or more banks are to be transitioned from the first power mode to the second power mode. In these embodiments, when transitioning the determined at least one bank in the cache from the first power mode to the second power mode, the cache controller is configured to transition the two or more banks in the cache from the first power mode to the second power mode in the determined order.

### BRIEF DESCRIPTION OF THE FIGURES

FIG. 1 presents a block diagram illustrating a processor in accordance with some embodiments.

FIG. 2 presents a block diagram illustrating a cache in accordance with some embodiments.

FIG. 3 presents a block diagram illustrating a computing device in accordance with some embodiments.

FIG. 4 presents a flowchart illustrating a process for operating a cache in accordance with some embodiments.

FIG. 5 presents a flowchart illustrating a process for operating a cache in accordance with some embodiments.

FIG. 6 presents a flowchart illustrating a process for operating a cache in accordance with some embodiments.

FIG. 7 presents a block diagram illustrating a cache in accordance with some embodiments.

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

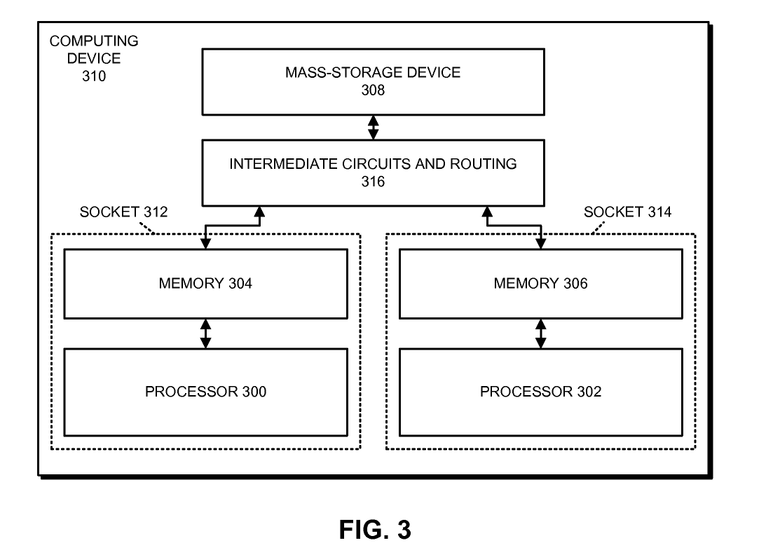

In some embodiments, a computing device (e.g., computing device 310 in FIG. 3) can use code and/or data stored on a computer-readable storage medium to perform some or all of the operations herein described. More specifically, the computing device can read the code and/or data from the computer-readable storage medium and can execute the code and/or use the data when performing the described operations.

A computer-readable storage medium can be any device or medium or combination thereof that can store code and/or data for use by a computing device. For example, the computer-readable storage medium can include, but is not limited to, volatile memory or non-volatile memory, including flash memory, random access memory (RAM, SRAM, DRAM, DDR, DDR2/DDR3/DDR4 SDRAM, etc.), read-only memory (ROM), and/or magnetic or optical storage mediums (e.g., disk drives, magnetic tape, CDs, DVDs). In the described embodiments, the computer-readable storage medium does not include non-statutory computer-readable storage mediums such as transitory signals.

In some embodiments, one or more hardware modules are configured to perform the operations herein described. For example, the hardware modules can comprise, but are not limited to, one or more processors/processor cores, application-specific integrated circuit (ASIC) chips, field-programmable gate arrays (FPGAs), caches/cache controllers, embedded processors, graphics processors/cores, pipelines, and/or other programmable-logic devices. When such hardware modules are activated, the hardware modules can perform some or all of the operations. In some embodiments, the hardware modules include one or more general-purpose circuits that are configured by executing instructions (program code, firmware, etc.) to perform the operations.

In the following description, functional blocks are referred to in describing some embodiments. Generally, functional blocks include one or more circuits (and, typically, multiple interrelated circuits) that perform the described operations. In some embodiments, the circuits in a functional block can include complex circuits that execute program code (e.g., program code, firmware, etc.) to perform the described operations.

### Overview

The described embodiments include a cache controller that maintains records of non-native cache blocks stored in banks in a cache and uses the records to determine one or more banks in the cache to be transitioned from a first power mode to a second power mode. Generally, from the perspective of a given bank in the cache, non-native cache blocks are cache blocks for which a home location for the cache block is in one of a predetermined set of memories, other caches, and/or other banks in the cache. In the described embodiments, the predetermined set of memories, other caches, and/or other banks can be defined based on the “effort” (in terms of electrical power, time, bandwidth consumption, etc.) needed to return a cache block to the memories, other caches, and/or other bank when the cache block is evicted from a given bank. For example, a memory, other cache, and/or other bank can be non-native when a cache block evicted from the memory, other cache, and/or other bank traverses more than a predetermined number and/or a predetermined type of circuit elements.

In transitioning a given bank in the cache from the first power mode to the second power mode, the cache controller can transition the given bank from any power mode supported by the given bank to any other power mode supported by the given bank. For example, the cache controller can transition the given bank from a full-power operating mode in which the given bank is operating normally to a power-off operating mode in which power to the given bank is shut off (thereby powering down the given bank). As another example, the cache controller can transition the given bank from the power-off operating mode to the full-power operating mode (thereby powering up the given bank).

In the described embodiments, transitioning a bank from the first power mode to the second power mode can include evicting cache blocks from the bank and/or other banks in the cache and transferring the evicted cache blocks to/from the given bank and/or other banks in the cache from/to a memory, a cache, and/or another cache block. Transferring the cache blocks can include forwarding the cache blocks through circuits elements and/or busses/wire routes, which can consume power and bandwidth and take time. By using the record of non-native cache blocks present in the banks in the cache to determine banks in the cache to be transitioned from a first power mode to a second power mode, the described embodiments can determine banks to be transitioned that involve evicting cache blocks with less effort (in terms of power, bandwidth, and/or time). These embodiments can therefore reduce the amount of power and bandwidth consumed and/or the time taken for transitioning cache banks between power modes. In this way, the described embodiments can enable improved switching between power modes, improve the performance of the cache banks and the cache in which the banks are located, and improve the performance of the system that includes the cache.

### Processor

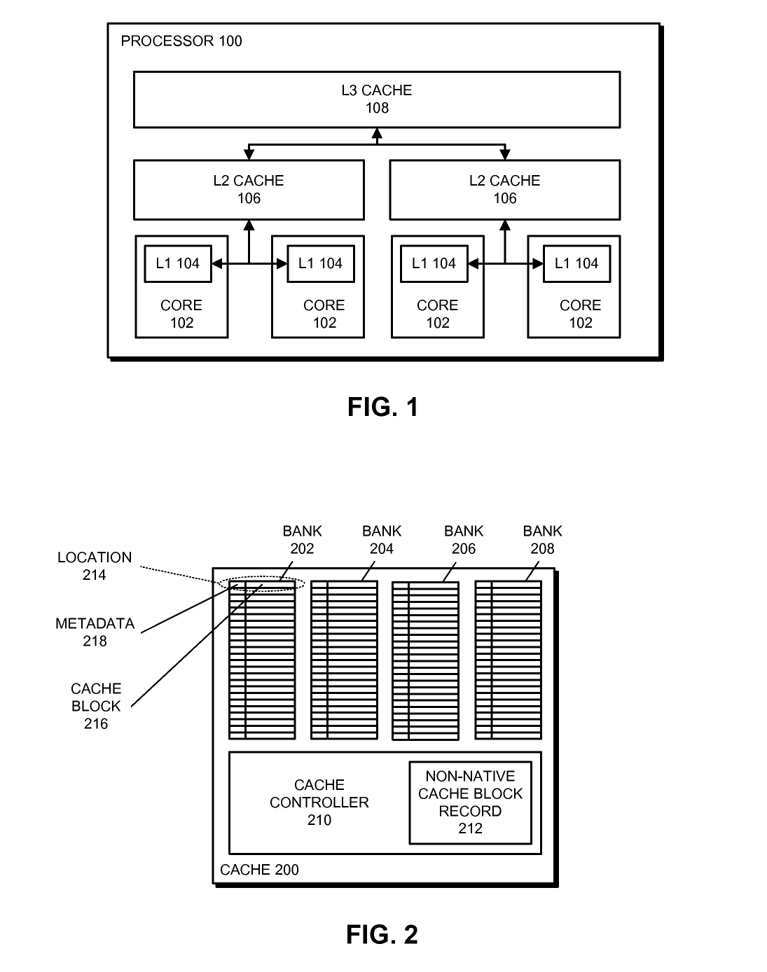

FIG. 1 presents a block diagram illustrating a processor 100 in accordance with some embodiments. As can be seen in FIG. 1, processor 100 includes four processor cores 102. Generally, each processor core 102 is a computational mechanism such as a central processing unit (CPU), graphics processing unit (GPU), or embedded processor that is configured to perform computational operations within processor 100.

Processor 100 also includes a hierarchy of cache memories (or “caches”) that can be used for storing instructions and data that is used by the processor cores 102. As can be seen in FIG. 1, the hierarchy of caches includes a level-one (L1) cache 104 (shown as “L1 104” in FIG. 1) in each processor core 102 that is used for storing instructions and data for use by the processor core 102. Generally, the L1 caches 104 are the smallest of a set of caches in computing device 310 (e.g., 96 kilobytes (KB) in size) and are located closest to the circuits (e.g., execution units, instruction fetch units, etc.) in the processor cores 102 that use the instructions and data that are stored in the L1 caches 104. The closeness of the L1 cache 104 to the circuits enables the fastest access to the instructions and data among the caches in the hierarchy of caches.

The level-two (L2) caches 106 are next in the hierarchy of caches in processor 100. Each L2 cache 106 is shared by two processor cores 102 and hence is used for storing instructions and data for both of the sharing processor cores 102. Generally, the L2 caches 106 are larger than the L1 caches 104 (e.g., 2048 KB in size) and are located outside, but close to, the processor cores 102 that share L2 cache 106 on the same semiconductor die as the sharing processor cores 102. Because L2 cache 106 is located outside the processor cores 102 but on the same die, access to the instructions and data stored in L2 cache 106 is slower than accesses to L1 cache 104, but faster than accesses to L3 cache 108.

The level-three (L3) cache 108 is next in the hierarchy of caches in processor 100 (and on the highest level of the hierarchy of caches in processor 100). The L3 cache 108, which is the largest cache in the hierarchy (at, e.g., 16 megabytes (MB) in size), is shared by all of the processor cores 102 and hence is used for storing instructions and data for all of the processor cores 102. L3 cache 108 is typically located on a separate die from processor cores 102, but so as to be accessible to all of the processor cores 102. Accessing data and instructions in L3 cache 108 is faster than accessing data and instructions in structures outside the processor (e.g., memory 304 or mass-storage device 308 in FIG. 3), but slower than accessing data and instructions in the other caches in the hierarchy.

In some embodiments, L1 cache 104, L2 cache 106, and L3 cache 108 (collectively, “the caches”) are fabricated from memory circuits. For example, the caches can be implemented in one or more of dynamic random access memory (DRAM), static random access memory (SRAM), double data rate synchronous DRAM (DDR SDRAM), and/or other types of integrated circuits.

Although an embodiment is described with a particular arrangement of processor cores, some embodiments include a different number and/or arrangement of processor cores. For example, some embodiments have only one processor core (in which case the caches hierarchy is used by the single core), while other embodiments have two, six, eight, or another number of processor cores—with the cache hierarchy adjusted accordingly. Generally, the described embodiments can use any arrangement of processor cores that can perform the operations herein described.

Additionally, although an embodiment is described with a particular arrangement of caches, some embodiments include a different number and/or arrangement of caches. For example, the caches (e.g., L1 cache 104, etc.) can be divided into separate instruction and data caches. Additionally, one or more of the caches that are shown as shared (e.g., L2 cache 106) may not be shared, and hence may only be used by a single processor core, or may be shared by more than the illustrated number of processor cores. As another example, some embodiments include different levels of caches, from only one level of cache to multiple levels of caches, and these caches can be located in processor 100 and/or external to processor 100. Generally, the described embodiments can use any arrangement of caches that can perform the operations herein described.

Moreover, although processor 100 is simplified for illustrative purposes, in some embodiments, processor 100 includes additional mechanisms for performing the operations of processor 100. For example, processor 100 can include power controllers, input-output mechanisms, communication mechanisms, networking mechanisms, display mechanisms, etc.

### Cache

FIG. 2 presents a block diagram illustrating a cache 200 in accordance with some embodiments. Cache 200 is a general example of an internal configuration that may be implemented in any of the caches in the described embodiments. For example, some or all of L1 cache 104, L2 cache 106, and L3 cache 108 can have, but are not required to have, internal configurations similar to cache 200.

As can be seen in FIG. 2, cache 200 includes a set of banks 202-208 and a cache controller 210. Each of the banks 202-208 includes memory circuits (e.g., DRAM, DDR SDRAM, etc.) divided into a set of locations, each location configured to store a cache block and metadata that includes information about the cache block (tags, indicators, flags, etc.). A cache block 216 and corresponding metadata 218 are labeled for exemplary location 214 in bank 202. Note that a cache block can comprise anything from a single byte to a cache line to a block of two or more cache lines.

In some embodiments, the metadata in each location in banks 202-208 includes at least one flag or indicator that can be updated to indicate that the cache block is non-native to the corresponding bank. For example, in some embodiments, the metadata in each location includes a flag bit that can be set (e.g., set to 1) to indicate that the corresponding cache block is non-native and cleared (e.g., set to 0) to indicate that the corresponding cache block is native. As another example, in some embodiments, the metadata in each location can be set to a given value to indicate not only that the cache block is non-native, but also a home location for the cache block. For instance, each home location for cache blocks can be assigned an N-bit numerical identifier, and metadata for the location can be updated with the numerical identifier when a cache block from the corresponding home location is stored in the location.

In some embodiments, the flag or indicator in the metadata for each location is not a dedicated/separate flag or indicator. Instead, in some embodiments, one or more bits that was historically used for another purpose can be set to indicate that the cache block is non-native. For example, these embodiments can repurpose and use one or more predetermined address bits, tag bits, and/or other metadata bits in the location to indicate that the cache block is non-native. In this way, the non-nativeness information can be stored in a given location without changing the existing memory (or metadata) size of the given location.

In some embodiments, when storing a cache block to a location in a bank, cache controller 210 determines if the cache block is non-native to the bank and, if so, sets the flag or indicator to indicate that the cache block stored in the location is non-native. For example, cache controller 210 can compare the address of a cache block to be stored in a bank to one or more records of non-native addresses to determine if the cache block is non-native, and/or can otherwise determine the home location for the cache block. By setting the flag bit in the metadata for the location in this way, cache controller 210 establishes a local record that simplifies a subsequent determination if the cache block is non-native. For example, when the cache block is subsequently evicted from cache 200, cache controller 210 can read the indicator in the metadata for the location to determine if the cache block is non-native (instead of performing a more complicated table lookup, address comparison, etc.).

Returning to FIG. 2, cache controller 210 is a functional block that performs various functions for controlling operations in cache 200. For example, cache controller 210 can manage storing cache blocks to, invalidating cache blocks in, and evicting cache blocks from cache 200; can perform lookups for cache blocks in cache 200; can handle coherency operations for cache 200; can respond to requests for cache blocks, and/or can perform other operations useful for controlling cache 200.

In addition to the above-described operations, in some embodiments, cache controller 210 can perform operations for maintaining a tracking mechanism for keeping track of non-native content in one or more banks in cache 200. For example, in some embodiments, the tracking mechanism includes a counter for each bank in a non-native cache block record 212 that is used for keeping track of a number of non-native cache blocks in the corresponding bank. As another example, in some embodiments, the tracking mechanism includes an aggregate separation variable that represents an aggregate separation that the non-native cache blocks in a corresponding bank are to traverse to be returned to a home location if evicted from the bank that is used for keeping track of the total or average separation to be traversed by non-native cache blocks in the corresponding bank. (Aggregate separation variables are described in more detail below.)

In these embodiments, as a cache block is stored in a bank in cache 200, cache controller 210 can determine if the cache block is non-native, and can update the tracking mechanism in non-native cache block record 212 accordingly. For example, in embodiments where the tracking mechanism includes the counter in non-native cache block record 212, cache controller 210 can increment a corresponding counter for the bank in non-native cache block record 212 when a non-native cache block is stored in the bank. As another example, in embodiments where the tracking mechanism in non-native cache block record 212 includes an aggregate separation variable, cache controller 210 can compute an update value based on the home location of the cache block and can increase the aggregate separation variable by the update value.

In addition, in these embodiments, as a cache block is evicted from a bank in cache 200, cache controller 210 can determine if the cache block is non-native (e.g., by reading the metadata for the location where the cache block is stored, by comparing an address for the cache block to a record of non-native addresses, etc.) and can update the tracking mechanism in non-native cache block record 212 accordingly. For example, in embodiments where the tracking mechanism includes the counter in non-native cache block record 212, cache controller 210 can decrement a corresponding counter for the bank in non-native cache block record 212 when a non-native cache block is evicted from in the bank. As another example, in embodiments where the tracking mechanism in non-native cache block record 212 includes an aggregate separation variable, cache controller 210 can compute an update value based on the home location of the cache block and can then decrease the aggregate separation variable by the update value.

In some embodiments, cache controller 210 can also use non-native cache block record 212 for determining a value representing non-native cache blocks stored in at least one bank in the cache and, based on the determined value, can determine at least one bank in the cache to be transitioned from a first power mode to a second power mode. For example, in embodiments where non-native cache block record 212 includes a counter with a count of the non-native cache blocks in each bank in cache 200, cache controller 210 can use the count of the non-native cache blocks in the bank in the cache as the value representing the non-native cache blocks stored in the bank. As another example, in embodiments where non-native cache block record 212 includes the aggregate separation variable, cache controller 210 can use the value of the aggregate separation variable as the value representing the non-native cache blocks stored in the bank. In some embodiments, cache controller 210 can preferentially transition a first bank rather than a second (a third, etc.) bank between power modes when the value representing the non-native content for the first bank better matches a predetermined condition. For example, when the value representing the non-native content for the first bank is greater than, less than, closer to a target value, etc. than the value representing the non-native content for the second bank.

Although embodiments are described where cache controller 210 performs operations for determining if cache blocks are non-native to cache 200 and maintaining non-native cache block record 212, in some embodiments, these operations are performed by other mechanisms in a computing device (e.g., computing device 310 in FIG. 3) in which cache 200 is located. For example, some embodiments, include a determiner circuit (not shown) outside the caches in the computing device that monitors cache blocks being stored in one or more caches and maintains a non-native cache block record for use as herein described. In these embodiments, the determiner circuit can work with the cache controller for transitioning banks of cache 200 between power modes.

In addition, although cache 200 is described using certain functional blocks and a particular number of banks, alternative embodiments include different numbers and/or types of functional blocks and/or banks (e.g., 16 banks, etc.). Additionally, some embodiments use a different subdivision of the cache, which can include any number of cache blocks, etc. Generally, the described embodiments can include any functional blocks and/or banks in cache 200 that enable the operations herein described.

### Computing Device

FIG. 3 presents a block diagram illustrating a computing device 310 in accordance with some embodiments. In computing device 310, processor 300 is coupled to memory 304 and processor 302 is coupled to memory 306. Memory 304 and memory 306 are in turn coupled to mass-storage device 308 and each other via intermediate circuits and routing 316. In some embodiments, processors 300 and 302 are similar to processor 100 and hence include processor cores and a cache hierarchy such as shown in FIG. 1.

Memory 304 and memory 306 are memory circuits that form a main memory of computing device 310 (and memory 304 and memory 306 are collectively referred to as “main memory”). The main memory is shared by both processors 300 and 302, and hence is used for storing instructions and data for both processor 300 and 302. In other words, processors 300 and 302 can access instructions and data in both memory 304 and 306. In some embodiments, memory 304 and memory 306 each hold separate portions of the data and instructions that can be held in the main memory. For example, assuming main memory is a total of 32 GB in size, memory 304 can include storage for the first/lowest 16 GB in the main memory and memory 306 can include storage for the second/highest 16 GB in the main memory. In some embodiments, a home location for a cache block can be in memory 304 or memory 306, depending on the address for the cache block. Accessing data and instructions in the main memory is faster than accessing data and instructions in mass-storage device 308, but slower than accessing data and instructions in the caches.

In some embodiments, the main memory is fabricated from memory circuits. For example, main memory can be implemented in one or more of dynamic random access memory (DRAM), double data rate synchronous DRAM (DDR SDRAM), and/or other types of integrated circuits.

As can be seen in FIG. 3, processor 300 and memory 304 are located in socket 312, and processor 302 and memory 306 are located in socket 314. Generally, sockets 312 and 314 each include physical connections for the package(s) that include the corresponding processor and memory. For example, the physical connections can include plugs, electrical connections, and/or other connections used for coupling the corresponding processor and memory to a circuit board, as well as possibly including wiring and other circuit elements for the corresponding processor and memory. In some embodiments, cache blocks stored in banks in a cache in a given processor (e.g., processor 300 in socket 312) can be non-native when a home location for the cache block is in the memory (or a cache in a processor in) the other socket (e.g., memory 306 in socket 314).

Mass-storage device 308 is a non-volatile memory such as a disk drive or a large flash memory that is the largest repository for data and instructions in computing device 310. As with the main memory, mass-storage device 308 is shared by processors 300 and 302. Although mass-storage device 308 stores significantly more data and instructions than main memory and/or any of the caches, accessing data and instructions in the mass-storage device 308 takes the longest time of any access in computing device 310. As an example, mass-storage device 308 is 4 terabytes (TB) in size.

Intermediate circuits and routing 316 can include latches, repeaters, functional blocks, switches, wire routes, busses, and/or other circuit elements through which cache blocks that are transmitted from caches on processors 300 and 302 are transferred to reach memories 306 and 304, respectively (as well as caches in the processors in the other socket). In some embodiments, transferring cache blocks from processors 300 and 302 to memories 306 and 304, respectively, through intermediate circuits and routing 316 (as well as caches in the processors in the other socket) takes additional time and consumes power and bandwidth when compared with transferring cache blocks from processors 300 and 302 to the memory 304 and 306 in the same socket. For this reason, in some embodiments, cache blocks with a home location in memory 304 or a cache in socket 312 can be regarded as non-native in cache banks in processor 302 and cache blocks with a home location in memory 306 or a cache in socket 314 can be regarded as non-native in cache banks in processor 300. Additionally, cache blocks with a home location in a memory in a same socket can be regarded as native in corresponding cache banks.

Although an embodiment is described where memory 304 and memory 306 located in separate sockets 312 and 314, respectively, in alternative embodiments, memory 304 and memory 306 are not located in separate sockets. For example, in some embodiments, memory 304 and memory 306 are implemented as two or more integrated circuit chips in the same package or implemented on a single integrated circuit chip. In some embodiments, memories 304 and 306 are included as several dual-inline memory modules on a circuit board.

In addition, although FIG. 3 includes various processors, caches, main memory, and mass-storage device 308, some embodiments include a different number and/or arrangement of processors, caches, memory, and/or mass-storage devices. Generally, the described embodiments can use any arrangement of processors, caches, memories, and/or mass-storage devices that can perform the operations herein described.

### Non-Native and Native Cache Blocks

As described above, in the described embodiments, cache blocks can be regarded as native to a bank in a cache or non-native to the bank. The described embodiments use the distinction between native and non-native cache blocks when making determinations about banks in a cache to be transitioned from a first power mode to a second power mode. Generally, the described embodiments transition banks in the cache between power modes in such a way as to avoid incurring unnecessary effort for transferring non-native blocks from banks in the cache. For example, some embodiments can choose banks to be transitioned (or not transitioned) between power modes based on a count of non-native cache blocks in banks in the cache. As another example, some embodiments can choose banks to be transitioned (or not transitioned) between power modes based on a total or average separation traversed by the non-native cache blocks in banks in the cache.

As indicated above, in some embodiments, a distinction between native and non-native cache blocks lies in relative amounts of “effort” needed for returning a cache block from a given bank to a home location in a memory, a cache, and/or another bank upon evicting the cache block from the given bank. In these embodiments, “effort” is a general metric that can include one or more individual metrics such as the power consumed by circuits in returning the cache block, time spent returning the cache block, bandwidth consumed on communication circuits used for returning the cache block, and/or other individual metrics. Generally, returning a native cache block to a home location for the cache block upon eviction from a given bank requires less effort than returning a non-native cache block from the same bank to a home location for the cache block upon eviction.

In some embodiments, non-nativeness for cache blocks is defined for a cache as a whole—i.e., is defined in the same way for every bank in the cache. In these embodiments, using an exemplary cache “A” in processor 300 as an example (which can be, e.g., L2 cache 106 in processor 300), each other cache and/or memory in computing device 310 to which cache blocks may be returned upon eviction from the cache A can be defined as non-native or as native. For example, a cache controller 210 in cache A can perform one or more operations to determine the effort for returning cache blocks to each other cache and/or memory (sending query packets and inspecting/timing a response, determining circuits between cache A and each other cache and/or memory, etc.) and can define each cache or memory as native or non-native. As another example, an operating system in computing device 310, a designer/system administrator, and/or another entity can inform cache controller 210 of the effort for returning cache blocks to each other cache and/or memory (and let cache controller 210 define each other cache and/or memory as native or non-native) and/or directly define each cache and/or memory as native or non-native. In these embodiments, when any cache block is stored in any bank in cache A, the cache block can be classified in accordance with the designated native or non-native status of the memory and/or cache (i.e., home location) to which the cache block is to be returned upon eviction.

In some embodiments, with regard to cache A in the example above (which, it will be recalled, is a cache in processor 300 in socket 312), memory 306 and all caches in processor 302 in socket 314 can be designated as non-native because cache blocks to be returned from cache A to memory 306 and/or caches in processor 302 are to be transferred through intermediate circuits and routing 316 upon eviction from cache A (with the attendant delay and power/bandwidth consumption). In contrast, memory 304 and all caches in processor 300 in socket 312 can be set as native because cache blocks to be returned from cache A to memory 304 and/or caches in processor 300 are not transferred through intermediate circuits and routing 316.

In some embodiments, for each bank in a cache 200 (or for the banks in cache 200 collectively), cache controller 210 can maintain one or more records that identifies sources for non-native cache blocks (where the sources are, e.g., the memories, caches, and/or cache banks that are home locations for the cache blocks). For example, in each record, cache controller 210 can keep a record of one or more addresses for cache blocks and/or other information that identifies non-native cache blocks for the bank in the cache (e.g., source indications from messages to cache 200 that include the cache block, etc.). Upon receiving a cache block that is to be determined as native or non-native for a given bank, cache controller 210 can compare an address from the cache block and/or other information associated with the cache block to the record(s) that identify sources for non-native cache blocks to determine if the cache block is native or non-native for the bank. For example, cache controller 210 can compare at least one address for the cache block to at least one address from the record(s) that is designated non-native and based on the comparison, determine that the cache block is non-native (or is native). The records can be kept in registers, variables, tables, etc. in cache controller 210 that can be dynamically updated (i.e., updated as cache 200 operates).

Although embodiments are described where non-nativeness for cache blocks is defined for a cache as a whole (i.e., is defined in the same way for every bank in the cache), alternative embodiments define non-nativeness differently. For example, some embodiments can define non-nativeness on a per-bank basis. In these embodiments, cache blocks in a given bank that are to be returned to one or more other banks when, e.g., the other banks are transitioned from a power-off mode to a full-power mode (i.e., when a powered-down other bank is powered back up), can be considered non-native to the given bank, whereas cache blocks that are to remain in the given bank despite transitions in power modes in other banks can be considered native to the given bank. In these embodiments, cache controller 210 can maintain records such as the records described above to enable determinations about which cache blocks are non-native to given banks

### Aggregate Separation Variable

As described above, in some embodiments, the tracking mechanism that is used for keeping track of non-native content in one or more banks in cache 200 includes an aggregate separation variable that is used to record an aggregate separation between the corresponding cache bank and the home locations for the non-native cache blocks in memories, other caches and/or banks in the cache. In some embodiments, the separation can be computed using any technique that arrives at a value that represents the “effort” needed for returning a cache block from a given bank to a home location in a memory, a cache, and/or another bank upon evicting the cache block from the given bank. For example, in some embodiments, the aggregate separation variable can be computed in terms of a number and/or type of circuit elements (e.g., intermediate circuits and routing 316, caches/cache banks, sockets, processors, etc.) that are to be traversed in returning a cache block from a corresponding cache bank to the cache block's home location in a memory, other cache, and/or cache block. In these embodiments, larger separation values may be computed when more circuit elements are traversed.

In some embodiments, when storing a non-native cache block to a bank in the cache or evicting a non-native cache block from a bank in the cache, the cache controller 210 updates the aggregate separation variable as follows. Cache controller 210 first determines a separation between a home location for the cache block and the bank. For example, the cache controller 210 can examine address information and/or other information for or about the cache block to determine a memory, other cache, and/or bank that is the home location for the cache block. Cache controller 210 can then use the information about the home location and information about the circuits in computing device to determine the separation (e.g., number of circuit elements) that the cache block are to traverse when returned to the home location for the cache block upon eviction of the cache block from the cache. (Note that information for determining a home location for the cache block and a separation traversed by the cache block can have been earlier determined and/or acquired by the cache controller 210, for example, through requests and/or received as an input to cache controller 210 from, e.g., an operating system on computing device 310 and/or a system administrator or designer.)

Cache controller 210 can then compute an update value based on the separation. For example, in some embodiments, the update value can be equal to or otherwise related (i.e., proportional) to the number of circuit elements between the bank and a home location for the cache block. The cache controller 210 can then increase a value of the aggregate separation variable by the update value when a non-native cache block is stored to the bank and decrease the value of the aggregate separation variable by the update value when a non-native cache block is evicted from the bank. In these embodiments, a value in the tracking mechanism representing the non-native cache blocks stored in the bank is therefore equal to or otherwise related to (i.e., proportional to) a value of the aggregate separation variable for the bank.

### Processes for Operating a Cache

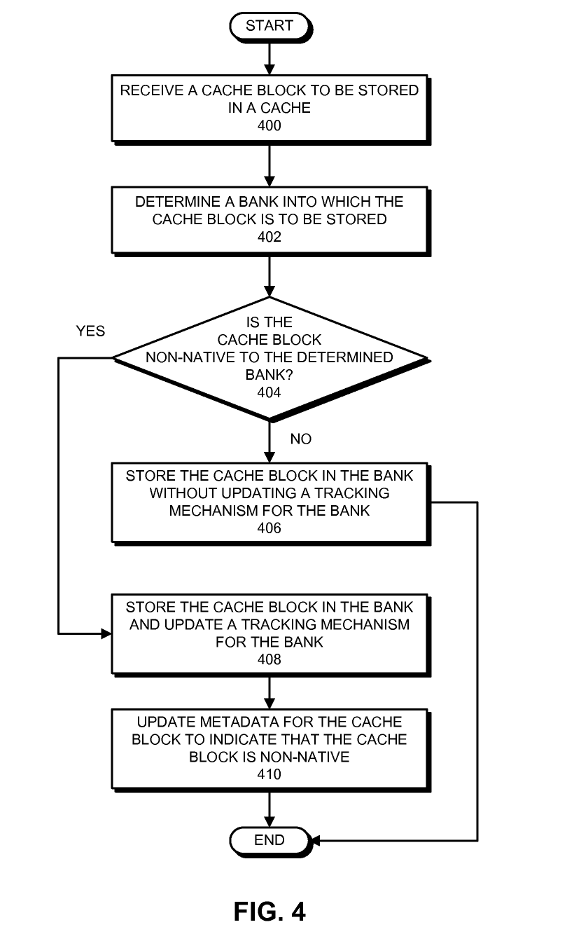

FIG. 4 presents a flowchart illustrating a process for operating a cache in accordance with some embodiments. Note that the operations in FIG. 4 are presented as a general example of some functions that may be performed by the described embodiments. The operations performed by some embodiments include different operations and/or operations that are performed in a different order. Additionally, for the example described in FIG. 4, it is assumed that the operations are performed by a cache such as cache 200 in FIG. 2, which can be any one of L1 cache 104, L2 cache 106, or L3 cache 108 in processors 300 or 302 in FIG. 3. However, the described embodiments are operable with other arrangements of caches and/or memories.

The process shown in FIG. 4 starts when cache controller 210 receives a cache block to be stored in cache 200 (step 400). Note that storing a cache block is described as an example, but any operation that adds cache blocks to a bank in the cache can be handled in a similar way, including coherency state changes, etc. Cache controller 210 then determines a bank into which the cache block is to be stored (step 402). For example, cache controller 210 can use an address for the cache block to determine a location in a bank in the cache into which the cache block is to be stored (perhaps based on one or more rules or policies, such as an associativity of the cache).

Cache controller 210 then determines if the cache block is non-native to the bank (step 404). Recall that cache controller 210 can maintain one or more records that identify sources for non-native cache blocks that can be used to determine if a given cache block is non-native for a given bank. Upon receiving the cache block, cache controller 210 can compare information associated with the cache block to the record(s) to determine if the cache block is native or non-native for the bank. For example, cache controller 210 can compare at least one address for the cache block to at least one address from the record(s) that is designated non-native and based on the comparison, determine that the cache block is non-native.

When the cache block is native to the bank (step 404), cache controller 210 stores the cache block in the bank without updating a tracking mechanism for the bank to which the cache block is stored (step 406). Recall that a cache block is native to the bank when a home location for the cache block (i.e., a location to which the cache block is to be returned when the cache block is evicted from the cache) is within a set of native home locations for cache blocks that can be partially or wholly defined by cache controller 210 and/or other entities. Note that, in alternative embodiments, the tracking mechanism may be updated. For example, where the tracking mechanism includes a value proportional to a ratio of non-native and native cache blocks in the bank.

When the cache is non-native to the bank (step 404), cache controller 210 stores the cache block in the bank and updates a tracking mechanism for the bank to which the cache block is stored (step 408). Recall that, in some embodiments, one or more banks in the cache is associated with a tracking mechanism in non-native cache block record 212 that is used for keeping a record of non-native cache blocks stored in the bank. In these embodiments, when storing a non-native cache block in a given bank in cache 200, cache controller 210 updates the tracking mechanism for the bank to indicate that the non-native cache block was stored in the bank. For example, in some embodiments, the tracking mechanism comprises at least a counter for each bank. In these embodiments, the cache controller 210 increments the counter for a bank as a non-native cache block is stored to the bank. As another example, in some embodiments, the tracking mechanism for each bank in the cache comprises at least an aggregate separation variable that is increased by an update value that is computed based on a home location for the cache block.

When the cache block is non-native, cache controller 210 can also update metadata for the cache block to indicate that the cache block (which is stored in a location in the bank) is non-native (step 410). For example, where the metadata includes a one-bit flag that indicates the non-nativeness of the corresponding cache block, cache controller 210 can set the one bit flag to 1. As another example, where the metadata contains a value that indicates both that the cache block is non-native and the home location for the cache block, cache controller can write an appropriate value into the metadata for the cache block.

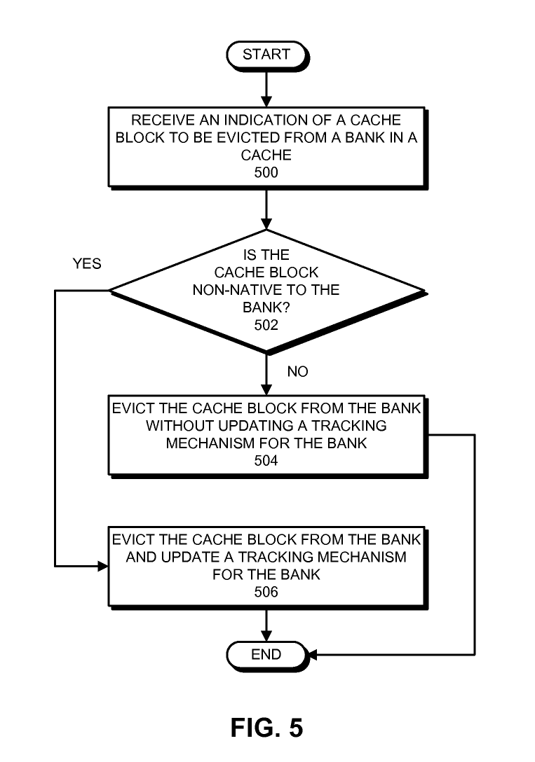

FIG. 5 presents a flowchart illustrating a process for operating a cache in accordance with some embodiments. Note that the operations in FIG. 5 are presented as a general example of some functions that may be performed by the described embodiments. The operations performed by some embodiments include different operations and/or operations that are performed in a different order. Additionally, for the example described in FIG. 5, it is assumed that the operations are performed by a cache such as cache 200 in FIG. 2, which can be any one of L1 cache 104, L2 cache 106, or L3 cache 108 in processors 300 or 302 in FIG. 3. However, the described embodiments are operable with other arrangements of caches and/or memories.

The process shown in FIG. 5 starts when cache controller 210 receives an indication that a cache block is to be evicted from a bank in a cache 200 (step 500). Note that evicting a cache block is described as an example, but any operation that removes cache blocks from a bank in the cache can be handled in a similar way, including invalidations, etc.

As part of a process for evicting the cache block, cache controller 210 determines if the cache block is non-native to the bank (step 502). Recall that, in some embodiments, metadata for cache blocks in cache 200 can include a flag/indicator that indicates whether each cache block is non-native (which was set as the cache block was stored in cache 200). In these embodiments, cache controller 210 can read metadata for the cache block to determine if the cache block is non-native. In other embodiments, cache controller 210 can perform other operations to determine if the cache block is non-native, including comparing an address or other information for the cache block to one or more records that identify sources for non-native cache blocks to determine if the cache block is non-native for the corresponding bank.

When the cache block is native to the bank, cache controller 210 evicts the cache block from the bank without updating a tracking mechanism for the bank from which the cache block is evicted (step 504). Note that, in alternative embodiments, the tracking mechanism may be updated. For example, where the tracking mechanism includes a value proportional to a ratio of non-native and native cache blocks in the bank.

When the cache is non-native to the bank, cache controller 210 evicts the cache block from the bank and updates a tracking mechanism for the bank from which the cache block evicted (step 506). For example, in some embodiments, the tracking mechanism comprises at least a counter for each bank. In these embodiments, the cache controller 210 decrements the counter for a bank as a non-native cache block is evicted from the bank. As another example, in some embodiments, the tracking mechanism for each bank in the cache comprises an aggregate separation variable that is decreased by an update value that is computed based on a home location for the cache block.

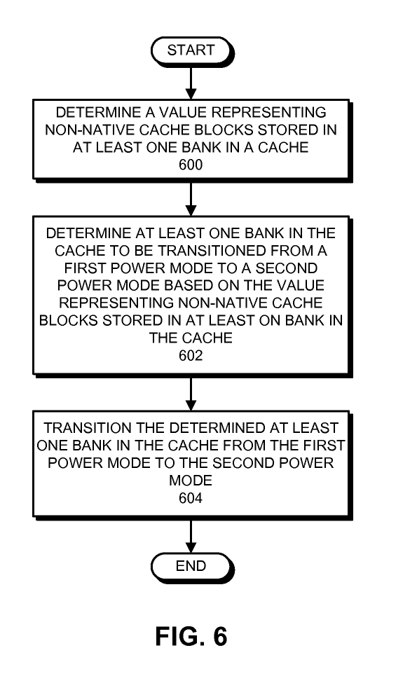

FIG. 6 presents a flowchart illustrating a process for operating a cache in accordance with some embodiments. Note that the operations in FIG. 6 are presented as a general example of some functions that may be performed by the described embodiments. The operations performed by some embodiments include different operations and/or operations that are performed in a different order. Additionally, for the example described in FIG. 6, it is assumed that the operations are performed by a cache such as cache 200 in FIG. 2, which can be any one of L1 cache 104, L2 cache 106, or L3 cache 108 in processors 300 or 302 in FIG. 3. However, the described embodiments are operable with other arrangements of caches and/or memories.

The process shown in FIG. 6 starts when cache controller 210 in cache 200 determines a value representing non-native cache blocks stored in at least one bank in cache 200 (step 600). Recall that, in some embodiments, non-native cache block record 212, which comprises one or more tracking mechanisms for keeping track of non-native cache blocks in each bank, is maintained by cache controller 210. One or more values from the tracking mechanisms can be used as the values representing the non-native cache blocks stored in the corresponding banks of cache 200. For example, in some embodiments, the tracking mechanism comprises at least a counter for each bank. In these embodiments, the value of the corresponding counter can be used as the value representing the non-native cache blocks stored in at least one bank in the cache. As another example, in some embodiments, the tracking mechanism for each bank in the cache comprises an aggregate separation variable. In these embodiments, the value of the aggregate separation variable can be used as the value representing the non-native cache blocks stored in at least one bank in the cache.

Cache controller 210 then determines at least one bank in the cache to be transitioned from a first power mode to a second power mode based on the value representing non-native cache blocks stored in the at least one bank in cache 200 (step 602). As described above, the described embodiments transition banks in the cache between power modes in such a way as to avoid incurring unnecessary effort for transferring non-native blocks from banks in the cache. For example, some embodiments can choose banks to be transitioned (or not transitioned) between power modes because the count of non-native cache blocks in one or more banks in the cache bears a predetermined relationship to the count of non-native cache blocks in another one or more other banks in the cache (e.g., is lower, is closer to a designated value, is higher, etc.). As another example, some embodiments can choose banks to be transitioned (or not transitioned) between power modes because the value of an aggregate separation variable for the one or more banks bears a predetermined relationship to the value of an aggregate separation variable for one or other banks in the cache (e.g., is higher, is lower, is closer to a designated value, etc.).

In some embodiments, the decision in step 602 includes another outcome (not shown), which includes determining that no banks to be transitioned between the first power mode and the second power mode. For example, if too many non-native cache blocks are located in each bank of cache 200, cache controller 210 may determine not to transition any banks. Alternatively, cache controller 210 can determine that banks should be transitioned between the first power mode and a different, third power mode. In this way, some embodiments can avoid the case where banks are transitioned to save power, but enough non-native cache blocks are present in the bank that transferring the non-native cache blocks may cost proportionally large amounts of time, power, and bandwidth (perhaps enough to offset any savings in power).

As an example, in some embodiments, when given a command to transition a bank from a full-power mode to a power-off mode, cache controller 210 can determine that a first bank in the cache with a higher count of non-native cache blocks is to be kept in the full-power mode, while a second bank is transitioned from the full-power mode to the power-off mode. Here, it is assumed that transitioning a given bank from the full-power mode to a power-off mode causes the bank to transfer any valid cache blocks to a memory, a cache, and/or another bank (that is to remain in the full-power mode) before transitioning, so choosing the bank with the lower count of non-native cache blocks can enable saving time, power, and communication bandwidth in computing device 310.

The cache controller 210 then transitions the determined at least one bank in the cache from the first power mode to the second power mode (step 604). In the described embodiments, transitioning the determined bank in the cache from the first power mode to the second power mode can include transitioning the bank from any first power mode in which the bank can be operated into any second power mode in which the bank can be operated. For example, in some embodiments, the bank can operate in two or more of a full-power mode where all of the circuits in the bank are functioning at full voltage, a reduced-power mode where power supplied to the bank has been reduced (e.g., by lowering voltage levels, individually powering down selected circuits in the bank, etc.) but power is still applied to at least a portion of the bank, a sleep mode where power is supplied to a minimal portion of the bank, and/or a power-off mode where power is not supplied to any portion of the bank. In these embodiments, the bank can be transitioned from a first higher-power mode, e.g., full-power mode, into a second lower-power mode, e.g., power off mode, or can be transitioned from a first lower-power mode, e.g., reduced power mode, in to a second higher-power mode, e.g., full-power mode.

In some embodiments, transitioning the at least one bank in the cache from the first power mode to the second power mode conserves power by powering-down at least one bank. In some embodiments, transitioning the at least one bank in the cache from the first power mode to the second power mode enables additional useful capacity (i.e., bank(s)) within the cache) by powering-up at least one bank from the power-off (or otherwise reduced power) mode.

In some embodiments, when determining a bank in the cache to be transitioned from a first power mode to a second power mode, cache controller 210 is configured to determine an order in which two or more banks are to be transitioned from the first power mode to the second power mode. For example, in a cache with eight banks, cache controller 210 can identify two (or more) of the banks to be transitioned from the first power mode to the second power mode, can determine an order in which the banks are to be transitioned, and can then transition the two or more banks from the first power mode to the second power mode in the determined order.

In some embodiments, the transitioning of the banks in the determined order does not necessarily occur at a same time. For example, cache controller 210 can determine an order in which two or more of the banks are to be transitioned from the first power mode to the second power mode and can then immediately transition only one of the banks to the second power mode. The other bank(s) can then be transitioned at a later time, and perhaps after one or more conditions have occurred. The conditions can include any relevant conditions, e.g., bandwidth consumption in the cache, a number of cache blocks in the banks to be transitioned or other banks, etc.

### Alternative Embodiments

As briefly described above, in some embodiments, non-nativeness for cache blocks is defined for individual banks in a cache with regard to other banks in the cache. In these embodiments, non-native cache blocks can include cache blocks transferred in to a given bank from another bank when the other bank is powered down, or when cache blocks are transferred out of the other bank and to the bank for another reason. Non-native cache blocks further include any cache block that is to be transferred back to the other bank when the other bank is powered back up or can otherwise accept transfer of cache blocks, including cache blocks written to a given bank because the other bank is unavailable for storing cache blocks.

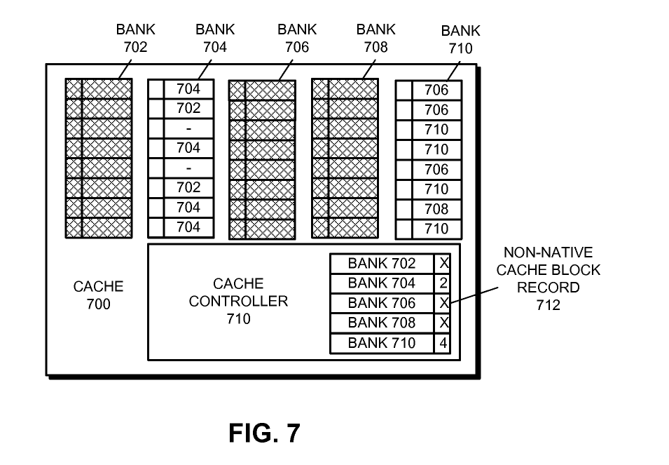

FIG. 7 presents a block diagram illustrating a cache 700 in accordance with some embodiments. Note that an additional, fifth, way has been added to cache 700 (in contrast with the four ways in cache 200 in FIG. 2). However, cache 700 (including cache controller 710 and non-native cache block record 712) otherwise functions similarly to cache 200 shown in FIG. 2.

As shown by hash marks in FIG. 7, banks 702 and 706-708 have been powered down (e.g., placed in a power-off mode), while banks 704 and 710 remain powered up (e.g., in a full-power mode). It is assumed for the example that, when banks 702 and 706-708 were powered down, cache blocks stored in bank 702 were transferred to bank 704 and cache blocks stored in banks 706-708 were transferred to bank 710, and any subsequently-stored cache blocks for banks 702 and 706-708 were stored in the corresponding powered up banks. It is further assumed that the cache blocks in the powered-up banks for the powered-down banks are to be transferred back to the powered-down banks when power is restored to the powered-down banks. Thus, cache blocks for the powered-down banks in the powered-up banks are regarded as non-native to the powered-up banks. The non-native cache blocks are shown with labels “702” in bank 704 and “706” and “708” in bank 710 (these labels indicate a home location for the cache block, assuming all banks were operating). Native cache blocks (cache blocks that are not to be transferred to banks 702 and/or 706-708 when the banks are powered back up) are marked 704 and 710, respectively (unused/invalid locations are marked with “-”).

Recall that, in some embodiments, non-native cache block record 712 includes a simple count of the non-native cache blocks in each bank in the cache. An example of this embodiment is shown in FIG. 7, where non-native cache block record 712 in cache 700 includes an exemplary entry indicating that a count of non-native cache blocks in bank 704 is two and the count for bank 710 is four. Banks 702 and 706-708 are powered down and therefore have no count in non-native cache block record 712 (although in some embodiments, these banks may include an indication of the previous count of non-native cache blocks in the bank).

The described embodiments can use the values in non-native cache block record to determine a bank to be transitioned from a first power mode to a second power mode. For example, that bank 704 should be a next bank to be powered down, because bank 704 contains less non-native cache blocks and less overall cache blocks than bank 710. As another example, that bank 702 should be the first powered-down bank to be powered back up because it has the lowest number of cache blocks to be transferred from another bank (here it is assumed that cache blocks for both banks 706 and 708 would be transferred to 708 upon the bank being powered up, but that need not be the case—and effects the outcome).

Recall also that, in some embodiments, non-native cache block record 712 can include an aggregate separation variable for each bank in which the total separation traversed, average separation traversed, and/or other representation of separation traversed by cache blocks to arrive in a bank is maintained. Although this embodiment is not shown in FIG. 7, using the arrangement shown in FIG. 7, for an embodiment uses aggregate separation variables, non-native cache block record 712 could include a value of 7 for bank 710, which is 3*2 for the three bank-706 non-native cache blocks in bank 710 that may need to be transferred to bank 708 if it is powered up and then be transferred from bank 708 to bank 706 when it is powered up (for a total of 3 cache blocks that may need to make 2 hops to return to their home location in bank 706) plus 1*1 for the one bank-708 non-native cache block in bank 710 (for a total of 1 cache block that is to make 1 hop to return to its home location in bank 708).

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for operating a cache with a plurality of banks, comprising:
in a cache controller for a cache, performing operations for:
determining a value representing non-native cache blocks stored in at least one bank in the cache, wherein a cache block is non-native to a bank when a home for the cache block is in a predetermined location relative to the bank;
based on the value representing non-native cache blocks stored in the at least one bank, determining at least one bank in the cache to be transitioned from a first power mode to a second power mode; and
transitioning the determined at least one bank in the cache from the first power mode to the second power mode.

2. The method of claim 1, wherein each bank in the cache comprises a tracking mechanism for keeping track of non-native cache blocks stored in the bank, and wherein the method further comprises:
when storing a non-native cache block in a bank in the cache, updating the tracking mechanism for the bank to indicate that the non-native cache block was stored in the bank; and
when evicting a non-native cache block from a bank in the cache, updating the tracking mechanism for the bank to indicate that the non-native cache block was evicted from the bank;
wherein determining the value representing non-native cache blocks stored in the at least one bank in the cache comprises acquiring the value from the tracking mechanism for the at least one bank.

3. The method of claim 2, wherein the tracking mechanism for each bank in the cache comprises a counter, and wherein the method further comprises:
incrementing the counter for a bank as a non-native cache block is stored to the bank and decrementing the counter for a bank as a non-native cache block is evicted from the bank,
wherein the value representing the non-native cache blocks stored in the bank is proportional to a value of the counter for the bank.

4. The method of claim 2, wherein the tracking mechanism for each bank in the cache comprises an aggregate separation variable, and wherein the method further comprises:
when a cache block is stored to a bank in the cache or a cache block is evicted from a bank in the cache, determining a separation between a home for the cache block and the bank;
computing an update value based on the separation; and
increasing a value of the aggregate separation variable by the update value as a non-native cache block is stored to the bank and decreasing the value of the aggregate separation variable by the update value as a non-native cache block is evicted from the bank,
wherein the value representing the non-native cache blocks stored in the bank is proportional to a value of the aggregate separation variable for the bank.

5. The method of claim 2, further comprising:
when storing a non-native cache block in a bank in the cache, updating metadata for the cache block to indicate that the cache block is non-native; and
when evicting a cache block from a bank in the cache,
responsive to reading the metadata for the cache block and determining that the evicted cache block is non-native, updating the tracking mechanism for the bank to indicate that the non-native cache block was evicted from the bank.

6. The method of claim 2, further comprising:
comparing at least one address for the cache block to at least one address that is predetermined to be non-native; and
based on the comparison, determining that the cache block is non-native.

7. The method of claim 1, wherein the predetermined location relative to the bank comprises another bank in the cache, another cache, or a memory.

8. The method of claim 1,
wherein the first power mode is a higher-power mode and the second power mode is a lower-power mode; or
wherein the first power mode is the lower-power mode and the second power mode is the higher-power mode.

9. The method of claim 1,
wherein determining at least one bank in the cache to be transitioned from a first power mode to a second power mode comprises determining an order in which two or more banks are to be transitioned from the first power mode to the second power mode; and
wherein transitioning the determined at least one bank in the cache from the first power mode to the second power mode comprises transitioning the two or more banks in the cache from the first power mode to the second power mode in the determined order.

10. An apparatus for operating a cache with a plurality of banks, comprising:
a cache controller configured to:
determine a value representing non-native cache blocks stored in at least one bank in the cache, wherein a cache block is non-native to a bank when a home for the cache block is in a predetermined location relative to the bank;
based on the value representing non-native cache blocks stored in the at least one bank, determine at least one bank in the cache to be transitioned from a first power mode to a second power mode; and
transition the determined at least one bank in the cache from the first power mode to the second power mode.

11. The apparatus of claim 10, further comprising:
a tracking mechanism in each bank in the cache for keeping track of non-native cache blocks stored in the bank;
wherein, when storing a non-native cache block in a bank in the cache, the cache controller is configured to update the tracking mechanism for the bank to indicate that the non-native cache block was stored in the bank;
wherein, when evicting a non-native cache block from a bank in the cache, the cache controller is configured to update the tracking mechanism for the bank to indicate that the non-native cache block was evicted from the bank; and
wherein, when determining the value representing non-native cache blocks stored in the at least one bank in the cache, the cache controller is configured to acquire the value from the tracking mechanism for the at least one bank.

12. The apparatus of claim 11, wherein the tracking mechanism for each bank in the cache comprises a counter, and wherein the cache controller is configured to:
increment the counter for a bank as a non-native cache block is stored to the bank and decrement the counter for a bank as a non-native cache block is evicted from the bank,
wherein the value representing the non-native cache blocks stored in the bank is proportional to a value of the counter for the bank.

13. The apparatus of claim 11, wherein the tracking mechanism for each bank in the cache comprises an aggregate separation variable, and wherein, as a cache block is stored to a bank in the cache or a cache block is evicted from a bank in the cache, the cache controller is configured to:
determine a separation between a home for the cache block and the bank;
compute an update value based on the separation; and
increase a value of the aggregate separation variable by the update value as a non-native cache block is stored to the bank and decrease the value of the aggregate separation variable by the update value as a non-native cache block is evicted from the bank,
wherein the value representing the non-native cache blocks stored in the bank is proportional to a value of the aggregate separation variable for the bank.

14. The apparatus of claim 11, wherein, when storing a non-native cache block in a bank in the cache, the cache controller is configured to update metadata for the cache block to indicate that the cache block is non-native; and
when evicting a cache block from a bank in the cache, responsive to reading the metadata for the cache block and determining that the evicted cache block is non-native, the cache controller is configured to update the tracking mechanism for the bank to indicate that the non-native cache block was evicted from the bank.

15. The apparatus of claim 11, wherein the cache controller is configured to:
compare at least one address for the cache block to at least one address that is predetermined to be non-native; and
based on the comparison, determine that the cache block is non-native.

16. The apparatus of claim 10, wherein the predetermined location relative to the bank comprises another bank in the cache, another cache, or a memory.

17. The apparatus of claim 10,
wherein the first power mode is a higher-power mode and the second power mode is a lower-power mode; or
wherein the first power mode is the lower-power mode and the second power mode is the higher-power mode.

18. The apparatus of claim 10,
wherein, when determining at least one bank in the cache to be transitioned from a first power mode to a second power mode, the cache controller is configured to determine an order in which two or more banks are to be transitioned from the first power mode to the second power mode; and
when transitioning the determined at least one bank in the cache from the first power mode to the second power mode, the cache controller is configured to transition the two or more banks in the cache from the first power mode to the second power mode in the determined order.

19. A computer-readable storage medium storing instructions that, when executed by a computing device, cause the computing device to perform a method for operating a cache with a plurality of banks, the method comprising:
determining a value representing non-native cache blocks stored in at least one bank in the cache, wherein a cache block is non-native to a bank when a home for the cache block is in a predetermined location relative to the bank;
based on the value representing non-native cache blocks stored in the at least one bank, determining at least one bank in the cache to be transitioned from a first power mode to a second power mode; and
transitioning the determined at least one bank in the cache from the first power mode to the second power mode.

20. The computer-readable storage medium of claim 19, wherein each bank in the cache comprises a tracking mechanism for keeping track of non-native cache blocks stored in the bank, and wherein the method further comprises:
when storing a non-native cache block in a bank in the cache, updating the tracking mechanism for the bank to indicate that the non-native cache block was stored in the bank; and
when evicting a non-native cache block from a bank in the cache, updating the tracking mechanism for the bank to indicate that the non-native cache block was evicted from the bank;
wherein determining the value representing non-native cache blocks stored in the at least one bank in the cache comprises acquiring the value from the tracking mechanism for the at least one bank.
